(19) United States
(12) Patent Application Publication
(10) Pub. No.: US 2023/0068331 A1
(43) Pub. Date: Mar. 2, 2023

(54) PENDULUM PAINTING ASSEMBLY

(71) Applicant: Signature Brands, LLC, Ocala, FL (US)

(72) Inventors: Charles HODGES, Clemmons, NC (US); Joshua Gordon, Ocala, FL (US)

(73) Assignee: Signature Brands, LLC, Ocala, FL (US)

(21) Appl. No.: 17/898,835

(22) Filed: Aug. 30, 2022

Related U.S. Application Data
(60) Provisional application No. 63/238,605, filed on Aug. 30, 2021.

(51) Int. Cl. B44D 3/00; B05C 5/00; B05C 11/10; B05C 13/02; B05D 5/06; B44C 5/00

(52) U.S. Cl. CPC B44D 3/00; B05C 5/002; B05C 11/10; B05C 13/02; B05D 5/06; B44C 5/00

(57) ABSTRACT

An assembly for decorating a plurality of objects, such as egg-shaped objects. The assembly has a support structure; a vessel for containing decorating material, with an dispensing opening at the bottom; a tether with a first tether end attached to the support structure and a second tether end attached to the vessel; and a substrate base for supporting the plurality of objects. The vessel is configured to swing freely over the objects on the substrate base to dispense the decorating material contained therein to the objects.

### CROSS-REFERENCE TO RELATED APPLICATION

This application claims benefit under 35 U.S.C. 119(e) of U.S. Provisional Patent application No. 63/238,605, filed Aug. 30, 2021, the entirety of which is hereby incorporated by reference herein.

### BACKGROUND OF THE INVENTION

### 1. Field of the Invention

The present invention is related to arts and crafts kits and, more particularly, to an assembly for decorating articles such as Easter eggs.

### 2. Related Art

The art of decorating eggs and similar objects has been practiced for centuries, such as colored Easter eggs intended primarily for the Easter season. Traditional assemblies for painting and/or dyeing Easter eggs require human interaction (usually children) with painting materials, a significant investment of time and energy, and can be quite messy and often stressful for parents who are left to clean up the mess once the dyeing and painting process is completed. Traditionally, Easter eggs have been dyed by dipping them in water containing a water-soluble dye, using a series of individual bowls in which a different colored dye mixture is contained in each bowl. The bowls generally take up most of the space on the table and spilling of the dye when moving the bowls to make extra work room is a frequently occurring problem. Although this has been an accepted practice for many years, dyeing eggs is usually a boring process for children, which creates a mess and in many cases produces unsatisfactory results.

Thus, some new methods and tools have been developed for achieving these decorations. However, most of the known devices often use complicated structures which do not lend themselves to inexpensive fabrication and use. For example, one known prior art, U.S. Pat. No. 3,792,163 (Fudro) provides an apparatus for holding and rotating an egg or other rounded object about its longitudinal axis and an arm member adapted to carry a marking device and arranged for marking movement longitudinally of the egg. In use, the user must fix the egg within the device's structure and then slowly rotates the egg to draw on the egg's surface. This technique requires a complicated rotation mechanism and tedious manual rotation for operation, with the disadvantages mentioned above. Thus, while the Fudro device allows the creation of patterns on the surface of the egg, it has disadvantages of complexity and limitation of only one egg per use. The large number of components required to produce the Fudro device makes it difficult to manufacture at a low cost. In addition to the above-mentioned difficulties, while such a device provides painting or dyeing to an egg, the device can only yield precisely controlled painting patterns. Thus, while the device provides decorations, it does not provide any artistic, creative, and unique colored designs on the egg surface.

### SUMMARY OF THE INVENTION

The present invention is related to an assembly for decorating articles, such as eggs, nuts, candies and other egg-shaped objects of the type commonly used as gifts and decorations on special holidays, such as Easter, Thanksgiving, and Christmas.

A purpose of the present invention is to provide a simple and inexpensive apparatus and also an entertaining method of decorating a plurality of objects, such as Easter eggs, simultaneously. A more specific object of this invention is to provide a novel apparatus and method of decorating, painting, and dyeing eggs to yield artistic effects thereon by creating novel and unique patterns capable of adding improved gift value. It is a further object of the invention to provide a decorating device which includes a surface to receive a substrate, namely, an object to be decorated, and support the same during decorating. The surface is also able to hold the decorating materials overflow and provide for easy cleaning.

In accordance with an aspect of the invention, an assembly for simultaneously decorating a number of substrates or objects, and in particular, eggs or egg-shaped objects, such as are used in Easter celebrations, is disclosed. The assembly is intended to provide an entertaining process for decorating a substrate such as eggs or egg-shaped objects with unique patterns for holiday use or display. The assembly has a support or frame for suspending a vessel containing a liquid craft or decorating materials (e.g., washable paint or the like) above the eggs or egg-shaped objects and a base for holding the eggs or egg-shaped objects underneath the vessel in a stable fashion. The assembly has sufficient rigidity to maintain an overall shape for support.

In another aspect, the vessel is designed such that it is suspended by a tie or tether connected to the frame or structure from above and can swing freely, in a pendulum motion, within a multiple-dimensional (e.g., 3D) space define by the frame. The vessel is designed to release the liquid craft or decorating materials onto the eggs or egg-shaped objects over a period of time during which the vessel is in the pendulum motion. The vessel is set into motion by a user releasing the vessel from a position higher than the vessel's static resting point, where it will then swing freely under gravitational force.

The liquid craft or decorating materials may comprise proprietary food-grade formulations for use with real eggs that may later be peeled and consumed.

The liquid craft or decorating materials may also comprise non-toxic formulations for egg-shaped objects that are not edible. The tether suspending the vessel can be rigid or flexible, but it is preferred that it is made of a relatively lightweight material compared to the filled vessel for more predictable/traditional pendulum behavior.

In another aspect, the tie or tether length can be sized such that the vessel will swing at a frequency that deposits the liquid craft or decorating materials onto the eggs or egg-shaped objects in a continuous or nearly continuous stream and at a speed that is enjoyable to the user. The frame or structure which suspends the vessel is designed such that its shape and dimensions allow the vessel to swing freely over an intended decorating area without contacting the frame or structure.

In another aspect, a substrate base for holding the eggs or egg-shaped objects for decoration can be designed to ensure minimal contact with the eggs or egg-shaped objects to maximize the available unobstructed surface area for decorating and to also minimize pooling of liquid craft or decorating materials on the eggs or egg-shaped objects. The substrate base can also be designed with a retaining wall to contain excessive liquid craft or decorating materials within the base in use.

In another aspect, the substrate base for holding the eggs or egg-shaped objects can also be designed to allow for rotation or pivoting about its center. In this embodiment, the user would be able to impart a spin to the substrate base about its axis during the decorating process in order to place the eggs or egg-shaped objects in motion at the same time when the vessel is also in motion to depose liquid craft or decorating materials more evenly. Alternatively, or in addition, a downward facing protrusion on the underside of the base will allow a user, during deposition of the liquid craft, to manually tilt the base by applying downward force along a periphery, to further enhance the decorating activity. These features would provide both additional visual entertainment and interaction and also allow for more variations in the decorating process. The substrate base could also be driven with an electric or manual (e.g. wind-up) motor instead of applying a manual spinning force from the user.

### BRIEF DESCRIPTION OF THE DRAWINGS

Other objects and features of the present invention will become apparent from the following detailed description considered in conjunction with the accompanying drawings. It is to be understood, however, that the drawings are designed solely for purposes of illustration and not as a definition of the limits of the invention, which is defined by the claims appended hereto. It should be further understood that the drawings are not necessarily drawn to scale and that, unless otherwise indicated, they are merely intended to conceptually illustrate the structures and procedures described herein. In the drawings:

FIG. 1 is an isometric view of the disclosed device in an assembled state before use, with a vessel containing a liquid craft or decorating materials shown in its static resting position;

FIG. 2 is an isometric view of the device during use, with the vessel containing the liquid craft or decorating materials being in motion;

FIG. 3 is an isometric view showing certain details of the vessel;

FIG. 4 is a detailed view of an embodiment in which an example of still another substrate base configuration which contains a spinning or tilting feature; and

FIG. 5 is a flowchart illustrating an example sequence of operating the device.

### DETAILED DESCRIPTION OF THE PRESENTLY PREFERRED EMBODIMENTS

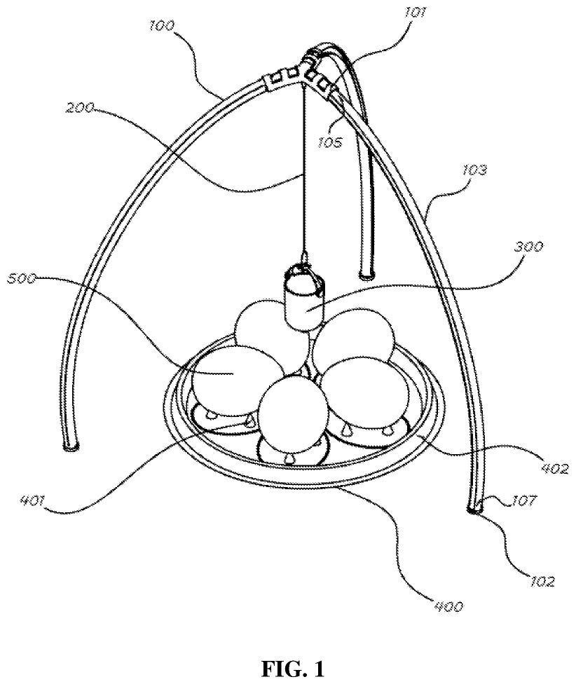

FIGS. 1-4 are schematic illustrations of a novelty pendulum painting assembly showing the components thereof as well as one or more eggs or egg-shaped objects to be decorated. It will be recognized that in most cases, the object to be decorated will be an egg-shaped decorative item, such as an Easter egg, however the invention is not limited to such an embodiment and, for example, the object to be decorated may be in other shapes instead of egg-shaped.

As will be discussed in detail below, the novelty design of the present invention permits a user to simultaneously decorate one or more objects, such as Easter eggs, in an entertaining way. The design will create attractive and unique patterns on the object to increase its aesthetic appearance, and also provide a simple solution for clean-up and storage after the decorating process.

FIG. 1 illustrates an embodiment of the device with five eggs or egg-shaped objects 500 positioned on an object holder or substrate base 400. The preferred embodiment of the device comprises a supporting frame or structure 100 dedicated to suspending a vessel 300 by a swing rope, tie, or tether 200. In the preferred embodiment, the structure 100 is configured as a tripod having a number of support elements or legs 103, with each leg having a first end 107 for resting on a flat surface, and a second end 105 releasably attached to a quick connector 101 as shown in FIG. 1. It should be understood that the quantity of such legs 103 may be modified within the scope of the invention with the only concept of the structure 100 being stable for supporting/suspending the vessel 300 via the tether 200 such that full swing may be accomplished. In some embodiments, a non-slip material or element 102 can be applied to each first end 107 to limit or prevent movement of the structure 100 on a support surface. In different embodiments, the non-slip element may be a rubber cap or footer on the first end 107. In some embodiments, the non-slip element 102 may also be interchangeable.

It should be noted that any suitable design for the frame or structure 100 for supporting/suspending the vessel 300 above objects 500 can be used, such as a partially closed-in box or the like, as long as its shape and dimensions allow the vessel 300 to swing freely over an intended decorating area while limiting or preventing contact with the frame or structure 100. In some embodiments, the structure 100 may be made from rigid materials, such as hard plastic or stainless steel, to provide sufficient rigidity to maintain an overall shape for support. In some embodiments, the overall support structure 100 can also include more user friendly features. For example, the structure 100 may be easy to assemble and disassemble for a compact storage by providing a friction fit or snap-fit connection between the ends 105 and the quick connector 101 without requiring the use of tools. In such embodiments, the support legs 103 may be readily removed when the toy is to be packed for shipment, or storage after use.

As shown, the tether 200 may have a first tether end attached to the support structure 100 and a second tether end attached to the vessel 300. In some embodiments, each end of the tether 200 may be in the form of an attaching element, such as a hook, for affixing to the support structure 100 and the vessel 300. It should be understood that the design of the tether 200 and its attaching element to the structure 100 and vessel 300 are such that the vessel 300 can swing freely underneath the overhead support provided by the structure 100, so long as the vessel 300 swings within the space envelope created by the legs 103 or other support elements of the structure 100.

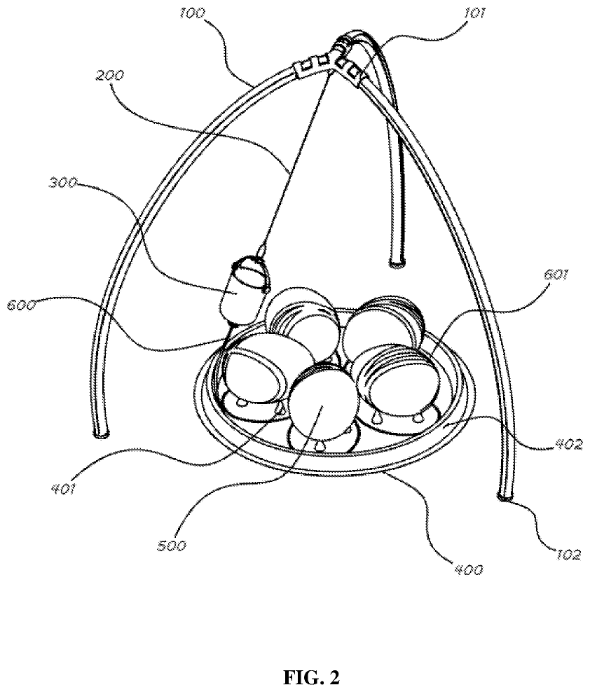

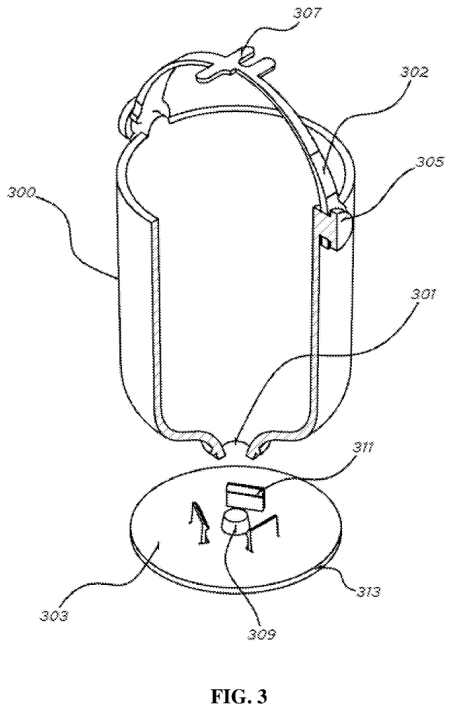

In some embodiments, the vessel 300 is configured as a bucket (see FIG. 3) to hold a volume of liquid craft or decorating material 600 (FIG. 2), and has a dispensing hole or opening 301 at the bottom of the vessel 300 through which the liquid craft or decorating material will flow onto the objects 500 to be decorated. The vessel opening 301 and liquid craft or decorating materials 600 are depicted in FIGS. 3 and 2, respectively. It is intended that the dimension of the opening 301 is designed such that the resulting rate of flow through the opening 301 produces an intended result of applying the vessel contents in a pleasing manner to objects 500 positioned below when the vessel 300 is in motion.

The liquid craft or material 600 used for decorating are well known and readily available commercially, such as water-soluble dyes approved by the Food and Drug Administration (FDA) and conventionally used to color eggs, including red, yellow, blue, brown, orange, green, pink, chartreuse, or combinations of the above. Tablets containing dyes such as sodium bicarbonate may also be used. Prior to use, the coloring dyes can be dissolved in a dilute acid, such as vinegar, in separate containers to provide one coloring dye per container, then the different coloring dye may be mixed in the vessel 300. In some embodiments, the liquid craft or decorating material 600 may be combinations of dyes, waxes, paints, frostings, or wrappings to make the decorations more attractive and colorful as gifts. It is also contemplated that different vessels can be provided, one for each intended color, and the vessels can be attached or detached from the frame 100 as desired.

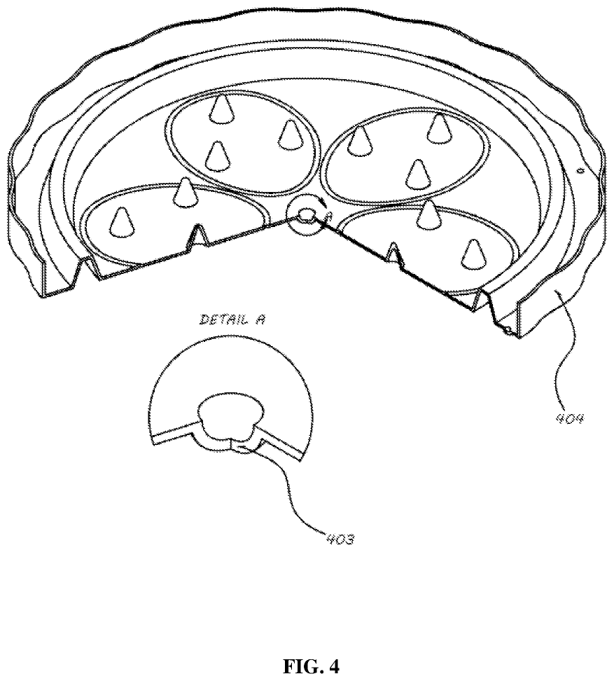

As shown here, the eggs or egg-shaped objects 500 are held in a stable manner under the vessel 300 on the object holder or substrate base 400. In some embodiments, the substrate base 400 may be a circular disk, but it should be understood that the substrate base 400 can be in any suitable shape as will be appreciated by those of ordinary skill. In some other embodiments, the substrate base 400 can also include an outer wall 402 with a flange or lip to contain excessive liquid craft or decorating material 600 during use. In some embodiments, the substrate base 400 may also include standoffs, anchors, or other securing features 401 (e.g., projections, protrusions) that are designed to hold the egg or egg-shaped objects 500 in a stable manner, preferably above any pooling of excess liquid craft, so as not to interfere with the decoration of the objects. For example, the projections 401 may be distributed over the surface holding the egg or egg-shaped objects 500 as best shown in FIG. 4.

In some embodiments, the substrate base 400 may have an explanation symbol or mark to facilitate the alignment of the substrate base 400 in a correct position relative to the structure 100. For example, when the substrate base 400 is in a circular disk configuration as shown here, a mark may be provided at the center of the substrate base 400 to align with the vessel opening 301 before use. It should be understood that the decoration patterns may vary due to the different positons of the substrate base 400 holding the eggs or egg-shaped objects 500.

FIG. 2 illustrates the device and method in operation with five eggs or egg-shaped objects 500. During use, the vessel 300, whether pre-filled or filled by the user with the liquid craft or decorating materials 600 selected by the user, is held at an angle away from its static resting position, then released from a displaced position from its static resting position with its vessel opening 301 unblocked and completes a series of oscillations. Typically, the vessel 300 will trace an elliptical path with a constantly decreasing magnitude and with the orientation of the elliptical shape constantly changing. The path that the vessel 300 traces results in unique patterns of liquid craft or decorating material deposits 601 on the eggs or egg-shaped objects 500 beneath the vessel 300.

FIG. 3 illustrates an exploded view of the vessel 300 with a removable cap 303 in some embodiments, depicting with a partial section view. If intended to be filled by the user, the vessel 300 can be designed such that it includes a means of attachment to the tether 200 such as a pivotable strap 302 that can be pivoted about protrusions 305 or flexed away for easier filling of the liquid craft or decorating materials 600 into the vessel 300. The strap 302 can also include an anchoring feature 307 to provide easy and releasable connection to a free end of the tether 200. It should be understood that the vessel 300 may also be filed without removing it from the structure 100.

In some embodiments, the cap 303 may have a plug 309 dimensioned for mating with the vessel opening 301 and be held in place by one or more snap-fit features 311 to prevent the liquid craft or decorating materials 600 leaking from the vessel 300. In such embodiments, the cap 303 can be easily removed by the user by applying a downward force to its edge 313 to disengage the snap-fit features 311 and plug 309 just prior to releasing the vessel 300 for oscillating motion. The cap 303 can also be designed to function as a stand, allowing the vessel 300 to be positioned on a flat surface for filling, without falling over.

It should be understood that although the vessel 300 is shown having a circular cross section in figures here, other shapes can suffice in order to provide a reservoir for the liquid craft or decorating material 600, such as a square or triangular cross section. In different embodiments, the vessel 300 can be provided pre-filled as a single-use container, or can be configured to allow for refilling. Likewise, the vessel 300 can be provided in an empty state for filling with one or more different material decided by the user.

In use, once the vessel 300 is released by a user, it is intended that all of the vessel contents, i.e. the liquid craft or decorating material 600, will exit the vessel 300 before the eggs or egg-shaped objects 500 are removed from the substrate base 400. Alternatively, however, the vessel 300 can be grasped by the user, and the opening 301 can be capped, such as by applying a user's thumb or using the cap 303 if equipped, thereby stopping the flow of the liquid craft or decorating material 600 to allow the eggs or egg-shaped objects 500 to be replaced or removed. In addition, one or more other vessels 300 containing difference colors of material 600 can be used, one after the other, to enhance the decoration.

In a still further embodiment, the disc-shaped substrate base 400 can be configured to allow for spinning or rotating or tilting about a point, such as at its center. For example, as best shown in FIG. 4, this can be accomplished by providing a protuberance 403 on the non-egg bearing surface, i.e., on an opposite surface of the bearing surface for supporting the one or more eggs or egg-shaped objects 500 or on the surface contacting a table or flat surface on which the substrate base 400 is placed. In such embodiments, the shape of the substrate base 400 can be configured to allow a user to grasp its periphery 404 and provide a gentle spinning motion and then activate the pendulum motion of the vessel 300, to thereby increase the entertainment and design effects produced by the disclosed device. In such embodiments, the substrate base 400 can be swirled by hand motion of a user or simply tilted by applying a downward force about different locations on the periphery to change orientation of the eggs relative to the depositing material 600. Alternatively, a manual or battery powered motor (not shown) may be provided to impart a spinning motion to the substrate base 400. It should be understood that although the substrate base 400 is shown as circular, other shapes can likewise be envisioned within the scope of the present disclosure.

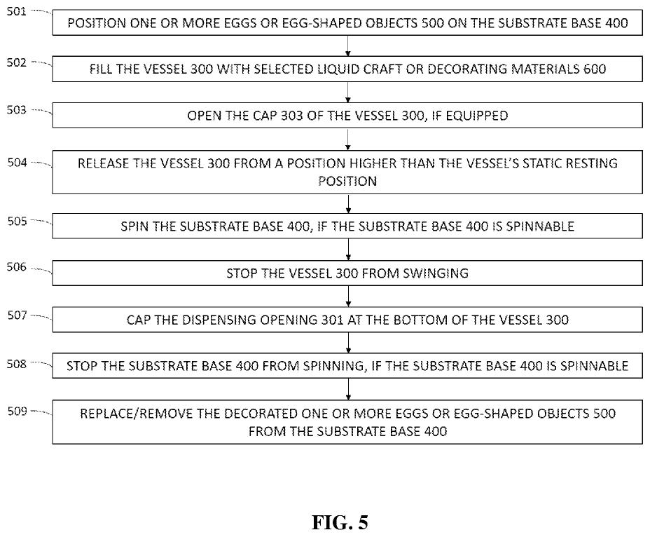

Referring now to FIG. 5, an embodiment of sequence for using the pendulum painting assembly described herein is illustrated. This sequence may be implemented by the users, such as children and/or their parents. At block 501, after assembly of the structure 100 the user will position one or more eggs or egg-shaped objects 500 on the substrate base 400, then the user may fill the vessel 300 with the liquid craft or decorating materials selected by the user at block 502 if the vessel 300 is not prefilled. If the vessel 300 is equipped with the cap 303, the user may first open the cap 303 at block 503 before releasing the vessel 300 from a position higher than the vessel's static resting position at block 504. It should be understood that the user may also release the vessel before opening the cap 303.

Next, if the substrate base 400 has a spinning feature, the user may start the spinning at block 505, either by hand motion of the user or by a motor if equipped. With the selected liquid craft or decorating materials 600 being dispensed onto the surfaces of the one or more eggs or egg-shaped objects 500, the user may stop the pendulum motion of the vessel 300 at block 506 if desired, e.g., by grasping it, when a desired decoration effect is achieved, or wait until all the selected liquid craft or decorating materials 600 are transferred onto the objects 500 to be decorated.

It should be understood that the user may impart the motion of the vessel 300 if desired during use such as by tilting the base about protuberance 403. For example, the user may allow the vessel 300 to swing or stop it from swinging at any time.

At block 507, the user may cap the vessel opening 301 using thumbs or by the cap 303 (if equipped) to stop the dispensing of the liquid craft or decorating materials 600. If the substrate base 400 is still spinning, the user may stop the spinning at block 508. At last, at block 509 the user may refill the existing vessel with a different color of material, replace the vessel with another one containing a different color to start the process again, and/or replace the decorated one or more eggs or egg-shaped objects 500 from the substrate base 400 with new ones to repeat the process, or just remove the decorated objects 500 from the base one the material 600 has dried or partially dried.

By virtue of the embodiments discussed above, a wide variety of unique patterns and coloring effects may be produced, dependent upon the particular design of the components of the assembly, such as the overall support structure 100, the tether 200, the vessel 300, the substrate base 400, etc., the characteristics and consistency of the liquid craft or decorating material 600, and the characteristics of the particular pendulum motion, such as the length of time of the motion and/or the motion magnitude.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

What is claimed is:

1. An assembly for decorating a plurality of objects, comprising:
a support structure defining a volume of space for the plurality of objects to be decorated;
a vessel for containing a decorating material, the vessel having a surface with an opening therein;
a tether with a first tether end attached to the support structure and a second tether end attached to the vessel; and
a substrate base for supporting and positioning the plurality of objects in the volume of space, wherein the vessel is configured to swing freely within the volume of space and above the plurality of objects to dispense the decorating material on the plurality of objects.

2. The assembly according to claim 1, wherein the support structure comprises a plurality of support legs, wherein each support leg has a first leg end and a second leg end.

3. The assembly according to claim 2, wherein the support structure is a tripod.

4. The assembly according to claim 2, wherein the support structure comprises a quick connector for connecting each first leg end together.

5. The assembly according to claim 2, wherein each second leg end further comprises a non-slip element.

6. The assembly according to claim 1, wherein the substrate base is in a round disk configuration.

7. The assembly according to claim 1, wherein the substrate base has an upstanding wall about its periphery.

8. The assembly according to claim 1, wherein the substrate base has protrusions for supporting the plurality of objects.

9. The assembly according to claim 1, wherein the substrate base is rotatable about an axis.

10. The assembly according to claim 9, wherein the substrate base has a protuberance on an opposite surface to the plurality of objects, the protuberance configured to allow rotation or pivoting of the substrate base with respect to the support structure.

11. The assembly according to claim 9, further comprising a motor for spinning of the substrate base.

12. The assembly according to claim 1, wherein the substrate base further comprises a guide for alignment of the substrate base relative to the support structure.

13. The assembly according to claim 1, wherein the vessel has a removable cap.

14. The assembly according to claim 13, wherein the removable cap further includes a plug and a snap-fit feature.

15. The assembly according to claim 1, wherein the vessel has a holder with an anchoring feature to provide easy and releasable connection to the tether.

16. An assembly for decorating a plurality of objects, comprising:
a support structure;
a vessel for containing a decorating material, with a dispensing opening at the bottom; and
a tether with a first tether end attached to the support structure and a second tether end attached to the vessel, wherein the vessel is configured to swing freely over the plurality of objects without contacting the support structure, to dispense the decorating material on the plurality of objects.

17. The assembly according to claim 16 further comprising a substrate base for holding objects to be decorated.

18. A method of decorating a plurality of egg-shaped objects with a decorating assembly having a support structure, a vessel for containing a decorating material, with a dispensing opening in the vessel, a tether with a first tether end attached to the support structure and a second tether end attached to the vessel, and a substrate base for supporting the plurality of egg-shaped objects, comprising:
a) positioning the plurality of egg-shaped objects on the substrate base;
b) connecting the vessel containing the decorating material to the support structure by the tether; and
c) releasing the vessel from a position higher than a static resting position of the vessel in order to impart swinging motion to the vessel so that the decorating material is deposited on the egg-shaped objects.

19. The method of claim 18, wherein the substrate base is rotatable, the method further comprises a step of spinning the substrate base during the swinging motion of the vessel.
